(19) United States
(12) Patent Application Publication
(10) Pub. No.: US 2005/0176876 A1
(43) Pub. Date: Aug. 11, 2005

(54) Water-whitening resistant pressure-sensitive adhesive

(76) Inventor: Sou Phong Lee, Arcadia, CA (US)

Correspondence Address: CHRISTIE, PARKER & HALE, LLP, PO BOX 7068, PASADENA, CA, 91109-7068, US

(21) Appl. No.: 10/774,617

(22) Filed: Feb. 9, 2004

(51) Int. Cl. C08K 3/00

(52) U.S. Cl. 524/556; 526/319

(57) ABSTRACT

Pressure-sensitive adhesive compositions that resist water-whitening are provided. The compositions comprise emulsion copolymers formed from a plurality of monomers that includes a plurality of (meth)acrylic monomers, at least one trifluoroalkyl(meth)acrylate monomer, and at least one alkylimidazolidone (meth)acrylate monomer. Preferably, the (meth)acrylic monomers comprise a plurality of soft monomers, at least one hard monomer and at least one acid monomer. The plurality of monomers may further include at least one aliphatic urethane di(meth)acrylate, an oligomer. The pressure-sensitive adhesive composition also comprises a surfactant system including at least one surfactant.

### FIELD OF THE INVENTION

The present invention pertains to pressure-sensitive adhesives, particularly emulsion-based acrylic pressure-sensitive adhesives which, when coated and dried as a film, resist water-whitening.

### BACKGROUND OF THE INVENTION

Historically, labels employing solvent-based pressure-sensitive adhesives have shown exceptional resistance to water-whitening. However, due to environmental considerations, emulsion-based pressure-sensitive adhesives are rapidly replacing the solvent-based pressure-sensitive adhesives. These emulsion-based pressure-sensitive adhesives typically show considerably less resistance to water-whitening than their solvent-based counterparts, but are more friendly to the environment and less expensive.

Emulsion-based pressure-sensitive adhesives are typically prepared in the presence of surfactants and other water soluble electrolytes such as initiators. Films cast from these emulsion-based pressure-sensitive adhesives, however, are sensitive to water, and whiten upon contact with only a drop of water.

The sensitivity of emulsion-based pressure-sensitive adhesives has long been attributed to the inclusion in the adhesives of water soluble electrolytes, surfactants, and polyelectrolytes such as sodium polymethacrylate. The inclusion of these ingredients is believed to enhance the sensitivity of the pressure-sensitive adhesive to water. Also, surfactants are known to migrate towards the surface of the film. This migration of surfactants to the film surface also enhances the sensitivity of the pressure-sensitive adhesive to water. Accordingly, reducing the amount of surfactant, and reducing or eliminating water soluble electrolytes, results in a decrease in the sensitivity of the pressure-sensitive adhesive to water, thereby increasing the adhesive's resistance to water-whitening. The crosslinking of emulsion particles has also been shown to increase the adhesive's resistance to water-whitening.

Recently, emulsion-based pressure-sensitive adhesives have been further improved to increase their resistance to water-whitening. For example, U.S. Pat. Nos. 6,569,949 B1 and 6,147,165, both to Lee et al., incorporated herein by reference, describe emulsion copolymer pressure-sensitive adhesives comprising alkyl acrylates, unsaturated carboxylic acids and hard monomers. While these emulsion copolymer pressure-sensitive adhesives exhibit good water-whitening resistance when coated on high-grade vinyl, they continue to whiten upon contact with water when coated on medium-grade vinyl. Because the volume of medium-grade vinyl films is considerably larger than the volume of high-grade vinyl, there is a continuing need for improved emulsion-based pressure sensitive adhesives that exhibit enhanced water-whitening resistance even when coated on medium-grade vinyl films.

### SUMMARY OF THE INVENTION

The present invention provides compositions useful as pressure-sensitive adhesives that are resistant to water-whitening, as well as labels and other sheet materials constructed with such adhesives. In one aspect, the invention is directed to a pressure-sensitive adhesive composition comprising a copolymer formed from a plurality of monomers including: (a) a plurality of (meth)acrylic monomers; (b) at least one trifluoroalkyl(meth)acrylate monomer; and (c) at least one alkylimidazolidone (meth)acrylate monomer. The presence of the trifluoroalkyl (meth)acrylate monomers and the alkylimidazolidone (meth)acrylate monomers appear to increase the ability of the pressure-sensitive adhesive to resist water-whitening, even when the adhesive is applied to medium-grade vinyl films.

In another aspect, the invention is directed to a pressure-sensitive adhesive composition comprising an emulsion copolymer formed from a plurality of monomers that includes: (a) a plurality of soft monomers; (b) one or more hard monomers; (c) one or more acid monomers; (d) at least one trifluoroalkyl(meth)acrylate monomer; and (e) at least one alkylimidazolidone (meth)acrylate monomer.

In a third aspect of the invention, soft monomers make up a major portion—at least 50%; more preferably from about 80% to 90% by weight—of the total weight of the monomers forming the copolymer, with the balance of monomers comprising one or more hard monomers (about 3% to 10% by weight, total), one or more acid monomers (about 3% to 8% by weight, total), at least one trifluoroalkyl(meth)acrylate monomer (about 0.5% to 2.5% by weight total), and at least one alkylimidazolidone (meth)acrylate monomer, present in a positive amount up to about 1% by weight, total.

In these and other aspects of the invention, the plurality of monomers may further include at least one aliphatic urethane di(meth)acrylate, an oligomer, in a total amount up to about 1.6% by weight, based on the total weight of the monomers. Including this oligomer in the copolymer further enhances the ability of the pressure-sensitive adhesive to resist water-whitening. In addition, the oligomer greatly improves the adhesive properties of the pressure-sensitive adhesive.

Pressure-sensitive adhesives according to these and other aspects of the invention preferably include a surfactant system. The surfactant system preferably comprises at least one surfactant having an ethylene oxide content of about 30 moles ethylene oxide to 1 mole surfactant.

The composition may also be crosslinked with at least one crosslinking agent, which can be an internal crosslinker (copolymerized with the plurality of monomers) or an external cross-linker added after polymerization of the plurality of monomers.

### BRIEF DESCRIPTION OF THE DRAWINGS

The attached drawings illustrate the results of the adhesive performance tests conducted on the emulsion copolymers of this invention as well as an emulsion copolymer control and a solvent copolymer control, wherein:

FIG. 1 is a chart reporting the results of opacity testing of the emulsion copolymer prepared according to a first embodiment of the present invention;

FIG. 2 is a chart reporting the results of opacity testing of the emulsion copolymer prepared according to a second embodiment of the present invention;

FIG. 3 is a chart reporting the results of 180° peel adhesion testing of emulsion copolymers prepared according to first and second embodiments of the present invention, after a 24-hour dwell time;

FIG. 4 is a chart reporting the results of 180° peel adhesion testing of emulsion copolymers prepared according to first and second embodiments of the present invention, after a 20-minute dwell time; and

FIG. 5 is a chart reporting the results of shear strength testing of emulsion copolymers prepared according to first and second embodiments of the present invention.

### DETAILED DESCRIPTION OF THE INVENTION

A pressure-sensitive adhesive composition useful for resisting water-whitening when coated and dried as a film is provided. In one embodiment, the pressure-sensitive adhesive composition comprises a copolymer formed from a plurality of monomers that includes:
(a) a plurality of (meth)acrylic monomers;
(b) at least one trifluoroalkyl(meth)acrylate monomer; and
(c) at least one alkylimidazolidone (meth)acrylate monomer.
   The addition of the trifluoroalkyl(meth)acrylate monomer and the alkylimidazolidone (meth)acrylate monomer increases the resistance of the pressure-sensitive adhesive to water-whitening.

In another embodiment, the pressure-sensitive adhesive composition comprises a copolymer formed from a plurality of monomers that includes:
(a) a plurality of soft monomers;
(b) at least one hard monomer;
(c) at least one acid monomer;
(d) at least one trifluoroalkyl(meth)acrylate monomer; and
(e) at least one alkylimidazolidone (meth)acrylate monomer.

In yet another embodiment, the pressure-sensitive adhesive composition comprises an emulsion copolymer formed from a plurality of monomers that includes:
(a) a major portion of a plurality of soft monomers;
(b) a minor portion of one or more hard monomers;
(c) a minor portion of one or more acid monomers;
(d) at least one trifluoro(meth)acrylate monomer; and
(e) at least one alkylimidazolidone (meth)acrylate monomer.
   As used here and in the claims, the term “major portion” refers to an amount of monomers greater than or equal to about 50% by weight, based on the total weight of the plurality of monomers. Accordingly, as used herein, the term “minor portion” refers to an amount of monomers less than about 50% by weight, based on the total weight of the plurality of monomers.

In a fourth embodiment, the pressure-sensitive adhesive composition comprises an emulsion copolymer formed from a plurality of monomers that includes, on a percent-by-weight basis, based on the total weight of monomers:
(a) about 80% to 90% of a plurality of soft monomers;
(b) about 3% to 10% of at least one hard monomer;
(c) about 3% to 8% of at least one acid monomer;
(d) about 0.5% to 2.5% of at least one trifluoroalkyl(meth)acrylate monomer.
(e) a positive amount up to about 1% of at least one alkylimidazolidone (meth)acrylate monomer.

These and other pressure-sensitive adhesive compositions according to the invention are formed by copolymerizing a plurality of monomers. In one embodiment, a single monomer charge containing all of the monomers to be polymerized is fed into a reactor over time, and allowed to react. In another embodiment, emulsion copolymers are prepared by sequential polymerization of two or more separate monomer charges. Alternatively, the pressure-sensitive adhesive compositions can be formed by separately copolymerizing two or more monomer mixtures and blending the resulting emulsion copolymers together to form an acrylic composition. In each case, the monomer charges have either the same composition or different compositions.

Polymerization is carried out by, e.g., preparing a pre-emulsion of monomers and commencing polymerization using free-radical initiators. The pre-emulsion can be introduced into the reactor as a single charge or fed incrementally to control the rate of reaction. In some embodiments, sequential polymerization is used, and two or more monomer charges are separately emulsified and allowed to react in distinct stages. To that end, separate pre-emulsions of monomers are prepared, a reactor is charged with an initial soap (surfactant) solution and a catalyst (initiator) solution; a first pre-emulsion from the first monomer charge is gradually fed into the reactor; and polymerization is initiated and allowed to propagate. The catalyst (initiator) solution can also be introduced after the first pre-emulsion is initially introduced into the reactor. After polymerization of the first pre-emulsion, a second pre-emulsion from the second monomer charge is gradually fed into the reactor and polymerization continues.

In some embodiments, the monomers used to prepare the emulsion copolymers include a plurality of (meth)acrylic monomers, at least one trifluoroalkyl(meth)acrylate monomer, and at least one alkylimidazolidone (meth)acrylate monomer. Optionally, at least one aliphatic urethane di(meth)acrylate oligomer is also included among the plurality of monomers.

As used here and in the claims, the term “(meth)acrylic” refers to both methacrylic and acrylic monomers. Similarly, the term “(meth)acrylate” refers to both methacrylates and acrylates. Non-limiting examples of (meth)acrylic monomers useful in the present invention include alkyl acrylates having about 4 to 12 carbon atoms in the alkyl group, for example 2-ethylhexyl acrylate, butyl acrylate, isooctyl acrylate, and isodecyl acrylate; (meth)acrylic acid monomers, for example acrylic acid, methacrylic acid, itaconic acid and fumaric acid; (meth)acrylate monomers, for example methyl methacrylate, n-hexyl methacrylate, ethyl methacrylate, isobutyl methacrylate and n-butyl methacrylate. Preferably, the plurality of (meth)acrylic monomers includes a mixture of alkyl acrylates having 4 to 12 carbons in the alkyl group; (meth)acrylic acid monomers; and short chain (meth)acrylate monomers.

In some preferred embodiments, the monomers used to prepare the emulsion copolymers include a plurality of soft monomers, at least one hard monomer, at least one acid monomer, at least one trifluoro(meth)acrylate monomer, and at least one alkylimidazolidone (meth)acrylate monomer. Optionally, at least one aliphatic urethane di(meth)acrylate oligomer is also included among the plurality of monomers.

As used here and in the claims, the term “soft monomers” refers to monomers which, when homopolymerized, form a polymer having a glass transition temperature (T_{g}) less than or equal to about 20° C. Preferably, the glass transition temperature is less than about 0° C. Non-limiting examples of soft monomers useful in the present invention include alkyl acrylates having about 4 to 12 carbon atoms in the alkyl group, for example 2-ethylhexyl acrylate, butyl acrylate, isooctyl acrylate, and isodecyl acrylate. Preferably, the plurality of soft monomers comprises 2-ethylhexyl acrylate and butyl acrylate. The total weight of the plurality of soft monomers preferably is from about 80% to 90% by weight, based on the total weight of the plurality of monomers. When the plurality of soft monomers comprises 2-ethylhexyl acrylate and butyl acrylate, the total weight of 2-ethylhexyl acrylate preferably is from about 10% to 22% by weight, based on the total weight of the plurality of monomers. Accordingly, the total weight of butyl acrylate is preferably from about 58% to 70% by weight, based on the total weight of the plurality of monomers.

As used here and in the claims, the term “acid monomers” refers to copolymerizable unsaturated carboxylic acids. Non-limiting examples of acid monomers useful in the present invention include acrylic acid, methacrylic acid, fumaric acid and itaconic acid. Preferably, the at least one acid monomer comprises both acrylic acid and methacrylic acid. The total weight of the at least one acid monomer is preferably from about 3% to 8% by weight, based on the total weight of the plurality of monomers. When the at least one acid monomer comprises acrylic acid and methacrylic acid, the total weight of methacrylic acid is preferably from about 2% to 5% by weight, based on the total weight of the plurality of monomers. Accordingly, the total weight of acrylic acid is preferably from about 2% to 5% by weight, based on the total weight of the plurality of monomers.

As used here and in the claims, the term “hard monomers” refers to monomers which, when homopolymerized, form a polymer having a glass transition temperature (T_{g}) greater than about 20° C. Non-limiting examples of hard monomers useful in the present invention include methyl methacrylate, styrene, n-hexyl methacrylate, ethyl methacrylate, isobutyl methacrylate and n-butyl methacrylate. Preferably, the at least one hard monomer comprises both methyl methacrylate and styrene. The total weight of the at least one hard monomer is preferably from about 3% to 10% by weight, based on the total weight of the plurality of monomers. When the at least one hard monomer comprises methyl methacrylate and styrene, the total weight of styrene is preferably from about 1% to 5% by weight, based on the total weight of the plurality of monomers. Accordingly, the total weight of methyl methacrylate is preferably from about 3% to 8% by weight, based on the total weight of the plurality of monomers.

A preferred trifluoroalkyl(meth)acrylate monomer is trifluoroethyl methacrylate, which is commercially available as “Matrife” through Elf Atochem (Moselle, France). The total weight of the trifluoroalkyl(meth)acrylate monomer(s) is preferably from about 0.5% to 2.5% by weight, based on the total weight of the plurality of monomers.

A preferred alkylimidazolidone (meth)acrylate monomer is ethylimidazolidone methacrylate, which is commercially available dissolved in methyl methacrylate as NORSOCRYL® 104 through Elf Atochem (Moselle, France). Ethylimidazolidone methacrylate is present in NORSOCRYL® 104 in an amount of from about 20% to 40% by weight based on the total weight of NORSOCRYL® 104, with methyl methacrylate making up the remainder. Alkylimidazolidone (meth)acrylate is preferably present in a positive amount up to about 1% by weight, based on the total weight of the plurality of monomers.

The plurality of monomers in each of the above embodiments of the pressure-sensitive adhesive preferably further comprises at least one aliphatic urethane di(meth)acrylate, an oligomer. The addition of this oligomer further enhances the ability of the pressure-sensitive adhesive to resist water-whitening. The oligomer also enhances the adhesive properties of the pressure-sensitive adhesive. The at least one aliphatic urethane di(meth)acrylate is preferably present in a positive amount up to about 1.6% by weight, based on the total weight of the plurality of monomers. An aliphatic urethane diacrylate commercially available as EBECRYL® 230 through UCB Radcure, Inc. (Smyrna, Ga.) is a preferred aliphatic urethane di(meth)acrylate, and has a molecular weight of about 5,000 g/mol.

Polymerization is carried out in the presence of one or more free radical initiators. Non-limiting examples of useful polymerization initiators include water-soluble initiators, for example, persulfates such as sodium persulfate and potassium persulfate; peroxides, such as hydrogen peroxide and tert-butyl hydroperoxide (t-BHP); and azo compounds, such as VAZO™ initiators. The initiators are alone or in combination with one or more reducing agents or activators, for example bisulfites, metabisulfites, ascorbic acid, erythorbic acid, sodium formaldehyde sulfoxylate (available from Henkel of America, Inc.), ferrous sulfate, ferrous ammonium sulfate, and ferric ethylenediaminetetraacetic acid. Enough initiator is used to promote free-radical polymerization of the monomers, for example about 0.15 to 0.5 parts by weight per about 100 parts by weight monomers.

In some embodiments, the plurality of monomers further includes a chain transfer agent or other molecular weight regulator to control average polymer chain length of the copolymers. Non-limiting examples of chain transfer agents useful in the present invention include n-dodecyl mercaptan (n-DDM), t-dodecyl mercaptan (t-DDM), monothioglycerol, mercapto acetates, and long chain alcohols. The chain transfer agent can be added to either or both monomer charges. If a chain transfer agent is included, the total weight of the chain transfer agent preferably is from about 0.01% to 5% by weight, based on the total weight of the monomers with which the chain transfer agent is allowed to react.

The emulsion copolymers of the present invention are prepared with excellent conversions at a reaction temperature of from about 75° C. to 85° C. in the presence of one or more catalysts, with the monomer mixture(s) being fed in over a period of about 3 to 5 hours. Reaction pH may be adjusted to within a range of from about 4.0 to 7.0 by addition of ammonia, sodium bicarbonate or another base.

If a higher cohesive strength adhesive is desired, the copolymers can be crosslinked by use of an internal and/or an external crosslinking agent. As used herein, the term “internal crosslinking agent” refers to a crosslinking agent that is copolymerized with a mixture of monomers. In contrast, the term “external crosslinking agent” refers to a crosslinking agent that is added after polymerization of the monomers. Internal crosslinking agents include at least two carbon-carbon double bonds per molecule and copolymerize with the plurality of monomers that form the adhesive copolymer. Non-limiting examples of internal crosslinking agents include diallyl maleate, diallyl phthalate, and multi-functional acrylates and methacrylates, such as polyethylene glycol diacrylate, hexanediol diacrylate, ethoxylated trimethylolpropane triacrylate, pentaerythritol triacrylate, propylene glycol diacrylate, tripropylene glycol triacrylate, and trimethylolpropane trimethacrylate. Non-limiting examples of external crosslinking agents include polyvalent metal salts or complexes, such as zirconium ammonium carbonate, zinc ammonium carbonate, aluminum acetate, zinc acetate, and chromium acetate. The presently preferred external crosslinking agent is zirconium ammonium carbonate, available as Bacote 20 through Magnesium Elektron, Inc. (Flemington, N.J.). When two monomer charges are used, both can contain a crosslinking agent. However, it is preferable to limit internal crosslinking to the first copolymer.

Emulsion polymerization is carried out in the presence of a surfactant system (soap solution). The surfactant system preferably contains at least one surfactant. More preferably, the surfactant system contains at least two surfactants. The total weight of the surfactant system may be from about 0.5 to 5 parts by weight to about 100 parts by weight of the monomers. More preferably, the total weight of the surfactant system may be from about 1 to 3 parts by weight to about 100 parts by weight of the monomers. A variety of nonionic, anionic and/or cationic surfactants may be used to prepare the copolymers. Preferably, however, a mixture of two or more surfactants is used. The presently preferred mixture of surfactants includes Aerosol® OT-75, a sodium dioctyl sulfosuccinate surfactant, available from Cytec (West Paterson, N.J.), Polystep® B-19, a sodium lauryl ether sulfate, available from Stepan Company, Inc. (Winnetka, Ill.), and Surfynol® 485W, an ethoxylated acetylenic diol surfactant, available from Air Products and Chemicals, Inc. (Allentown, Pa.). Other non-limiting examples of useful surfactants include Disponil® FES-77, a sodium lauryl ether surfactant, available from Cognis Corporation (Amber, Pa.). The surfactant system preferably comprises at least one surfactant having an ethylene oxide content of about 30 moles ethylene oxide to 1 mole surfactant. The surfactant system also preferably includes at least one defoamer, such as Drewplus® L-198, available from Ashland Chemical Company (Dublin, Ohio). A stabilizer, such as TSPP (sodium pyrophosphate) is also preferably included.

Prior to coating on a substrate, the pressure-sensitive adhesive compositions are advantageously modified by addition of one or more additional components, such as biocides and defoamers. Non-limiting examples of suitable biocides include Kathon LX, commercially available as a 1.5% solution from Rohn & Haas (Philadelphia, Pa.), and Metatin 910, commercially available from ACIMA (Buchs, Switzerland). Non-limiting examples of suitable defoamers include Drewplus® T-1201, Drewplus® 1-191 and Drewplus® L-198, commercially available from Ashland Chemical Company (Dublin, Ohio).

The pressure-sensitive adhesive compositions of the present invention provide both enhanced resistance to water-whitening and enhanced adhesive properties. The adhesives are particularly useful in marking films applications. In a typical construction, the facestock is calendered or cast vinyl (PVC), but other facestocks are also contemplated and within the scope of the invention. A marking film, adhesive label, or other adhesive construction is conveniently manufactured by coating the pressure-sensitive adhesive composition directly on the facestock. More preferably, the pressure-sensitive adhesive composition is coated on a release liner, such as silicone-coated paper or pre-siliconized polypropylene film, and then dried and laminated to the facestock. In use, the release liner is removed and the pressure-sensitive adhesive laminated facestock is then applied to the desired substrate, e.g., glass, stainless steel, plastic, etc. The pressure-sensitive adhesive compositions of the present invention provide enhanced water-whitening resistance on medium-grade vinyl as well as high-grade vinyl. Vinyl film is available from a wide variety of suppliers, well known to those skilled in the art. A partial listing is found in Modern Plastics, Mid-November 1997, at p. G-17, which is incorporated herein by reference.

### EXAMPLES

The following non-limiting examples illustrate the preparation and properties of pressure-sensitive adhesive compositions according to the present invention. In the examples and tables, the following abbreviations have the meaning shown:
TSPP: sodium pyrophosphate, a stabilizer
Aerosol OT-75: sodium dioctyl sulfosuccinate surfactant
Polystep B-19: sodium lauryl ether sulfate surfactant
Surfynol 485W: an ethoxylated acetylenic diol surfactant
Drewplus L-198: a defoamer
Matrife: trifluoroethyl methacrylate
Norsocryl 104: ethylimidazolidone methacrylate
Ebecryl 230: aliphatic urethane diacrylate
n-DDM: n-dodecyl mercaptan, a chain transfer agent
Kathon LX: a biocide

### Example 1

Emulsion copolymers were prepared by sequential polymerization using the components present in Table 1, according to the following protocol.

Soap solutions B(1) and B(2), monomer charges C(1) and C(2), and catalyst charge D were prepared in separate vessels. Pre-emulsions I and II were separately formed by combining soap solution B(1) with monomer charge C(1), and combining soap solution B(2) with monomer charge C(2). A jacketed, multi-neck reactor equipped with nitrogen inlet valve stirrer and thermometer was charged with initial reactor charge A without the potassium persulfate, the reactor atmosphere was purged with nitrogen, and the contents of the reactor were heated to 78° C., with agitation at about 130 to 150 μm. When the reactor temperature reached 78° C., the potassium persulfate from the initial reactor charge A was added and the purging of the reactor atmosphere with nitrogen was stopped. Pre-emulsion I was then fed into the reactor over time, with agitation. Catalyst charge D was fed into the reactor approximately 20 minutes after the start of the pre-emulsion I addition. The reaction temperature was maintained at 80° C. to 85° C. Approximately 5 minutes after completion of the pre-emulsion I feed, pre-emulsion II was fed into the reactor, with agitation, while the catalyst feed was continued. The catalyst addition was maintained for approximately 20 minutes after the completion of the pre-emulsion II addition. The total elapsed time of the pre-emulsion and catalyst feeds was about 5 hours.

The batch was maintained at 80° C. to 85° C. for approximately 90 minutes after the completion of the catalyst addition. Cooling of the batch was begun when the weight of residual monomers was below about 0.05% by weight. When the batch temperature reached about 65° C., the pH of the batch was raised by addition of 10% ammonia solution. Defoamer and biocide were added to the reactor when the temperature reached about 35° C. A small amount of deionized water was also added as a diluent.

The resulting formulation was translucent with a grit of 30 to 50 ppm on a 55 micron filter. The total solids content was 56.0±0.5%. The pressure-sensitive adhesive had a pH of 7.9±0.3.

TABLE 1

| A) Reactor charge: | Parts by weight |
|---|---|
| Di-H2O | 172.32 |
| Polystep B-19 | 2.86 |
| K-persulfate | 1.04 |
| Total | 176.22 |

| B) Soap Solution: | (1) | (2) |
|---|---|---|
| Di-H2O | 92.30 | 64.53 |
| T.S.P.P.(59.7%) | 0.13 | 0.09 |
| Aerosol OT-75 | 1.51 | 1.08 |
| Polystep B-19 | 7.19 | 5.04 |
| Surfynol 485W | 2.56 | 1.77 |
| Drewplus L-198 | 0.01 | 0.01 |
| Total | 103.70 | 72.52 |
| C) Monomer Mix: | (1) | (2) |
| 2-EHA | 47.89 | 33.77 |
| BA | 223.29 | 158.48 |
| MMA | 18.67 | 13.36 |
| Styrene | 11.66 | 8.35 |
| MATRIFE | 4.54 | 3.24 |
| MAA | 6.95 | 4.97 |
| AA | 10.16 | 7.26 |
| Norsocryl 104 | 1.63 | 1.17 |
| Ebecryl 230 | — | — |
| n-DDM | 0.11 | 0.40 |
| Total | 324.90 | 231.00 |

D) Catalyst Solution For Delay Addition:

| Di-H2O | 66.34 |
|---|---|
| K-persulfate | 1.04 |
| Total | 7.38 |
| E) 19% NH3 Sol'n | 9.80 |
| F) Drewplus L-198 | 0.30 |
| G) KathonLX (1.5%) | 0.20 |
| H) Di-H2O | 13.98 |
| Grand Total | 1000.00 |

| | Amount | Time | Rate |
|---|---|---|---|
| Delay Addition: | (parts by wt) | (min,) | (parts by wt/min.) |
| Pre-em (1) | 428.60 | 120 | 3.57 |
| Pre-em (2) | 303.52 | 85 | 3.57 |
| Catalyst | 67.38 | 210 | 0.32 |
| 10% NH3 Solution | 9.80 | 5 | 0.65 |

Specifications:
PH: 7.6-8.2
Solids: 56.00% + −0.5
Grits: 30-50 ppm on 55 micron filter
Viscosity: 1,500-3,000 cps., #3 spindle/30 rpm/25 C/LVT
Water-whitening Test on 940 Clear Vinyl or 701 PF Black Vinyl for a Zr-crosslinked version of this type of emulsion based polymer: visually, there is no sign of whitening after being immersed in Di-water for 12 HRS or 24 HRS, respectively.

### Example 2

Emulsion copolymers were prepared by sequential polymerization using the components present in Table 2, according to the following protocol.

Soap solutions B(1) and B(2), monomer charges C(1) and C(2), and catalyst charge D were prepared in separate vessels. Pre-emulsions I and II were separately formed by combining soap solution B(1) with monomer charge C(1), and combining soap solution B(2) with monomer charge C(2). A jacketed, multi-neck reactor equipped with nitrogen inlet valve stirrer and thermometer was charged with initial reactor charge A without the potassium persulfate, the reactor atmosphere was purged with nitrogen, and the contents of the reactor were heated to 78° C., with agitation at about 150 rpm. When the reactor temperature reached 78° C., the potassium persulfate from the initial reactor charge A was added and the purging of the reactor atmosphere with nitrogen was stopped. Pre-emulsion I was then fed into the reactor over time, with agitation. Catalyst charge D was fed into the reactor approximately 15 minutes after the start of the pre-emulsion I addition. The reaction temperature was maintained at about 80° C. to 85° C. Approximately 15 minutes after completion of the pre-emulsion I feed, pre-emulsion II was fed into the reactor, with agitation, while the catalyst feed was continued. The catalyst addition was maintained for approximately 15 minutes after the completion of the pre-emulsion II addition. The total elapsed time of the pre-emulsion and catalyst feeds was about 7½ hours.

The batch was maintained at 80° C. to 86° C. for approximately 60 minutes after the completion of the catalyst addition. Cooling of the batch was begun when the weight of residual monomers was below about 0.10% by weight. When the batch temperature reached about 65° C., the pH of the batch was raised by addition of 10% ammonia solution. Defoamer and biocide were added to the reactor when the temperature reached about 35° C. A small amount of deionized water was also added as a diluent.

The resulting formulation was translucent with a grit of 50 to 100 ppm on a 50 micron filter. The total solids content was 55.0±0.5%. The pressure-sensitive adhesive had a pH of 8.0±0.5.

TABLE 2

| A) Reactor charge: | Parts by weight |
|---|---|
| Di-H2O | 300.00 |
| Disponil FES 77 | 3.50 |
| K-persulfate | 1.65 |
| Total | 305.15 |

| B) Soap Solution: | (1) | (2) |
|---|---|---|
| Di-H2O | 130.33 | 102.67 |
| T.S.P.P.(59.7%) | 0.30 | 0.20 |
| Aerosol OT-75 | 3.08 | 2.14 |
| Disponil FES-77 | 13.64 | 9.46 |
| Surfynol 485W | 3.78 | 2.62 |
| Drewplus L-198 | 0.03 | 0.03 |
| Total | 151.16 | 117.12 |
| C) Monomer Mix: | (1) | (2) |
| 2-EHA | 92.00 | 68.20 |
| BA | 333.64 | 232.70 |
| MMA | 17.00 | 11.00 |
| Styrene | 9.00 | 6.00 |
| MATRIFE | 10.00 | 3.50 |
| MAA | 9.90 | 7.00 |
| AA | 14.20 | 10.00 |
| Norsocryl 104 | 2.10 | 1.50 |
| Ebecryl 230 | 4.00 | 2.50 |
| n-DDM | 0.16 | 0.60 |
| Total | 492.00 | 343.00 |

E) Catalyst Solution For Delay Addition:

| Di-H2O | 73.50 |
|---|---|
| K-persulfate | 1.50 |
| Total | 75.00 |
| E) 10% NH3 Sol'n | 30.00 |
| F) Drewplus L-198 | 0.50 |
| G) KathonLX (1.5%) | 0.30 |
| H) Di-H2O | 25.77 |
| Grand Total | 1540.00 |

| | Amount | Time | Rate |
|---|---|---|---|
| Delay Addition: | (parts by wt) | (min,) | (parts by wt/min.) |
| Pre-em (1) | 643.16 | 120 | 5.36 |
| Pre-em (2) | 460.12 | 86 | 5.36 |
| Catalyst | 75.00 | 226 | 0.33 |
| 10% NH3 Solution | 30.00 | 30 | 1.00 |

Specifications:
PH: 7.5-8.5
Solids: 55.00% + −0.5
Grits: 50-100 ppm on 50 micron filter
Viscosity: 1,500-3,500 cps., #3 spindle/30 rpm/25 C/LVT
Water Spot Test on 940 Clear Vinyl: no whitening within 4 hours.

Adhesive Performance and Test Methods

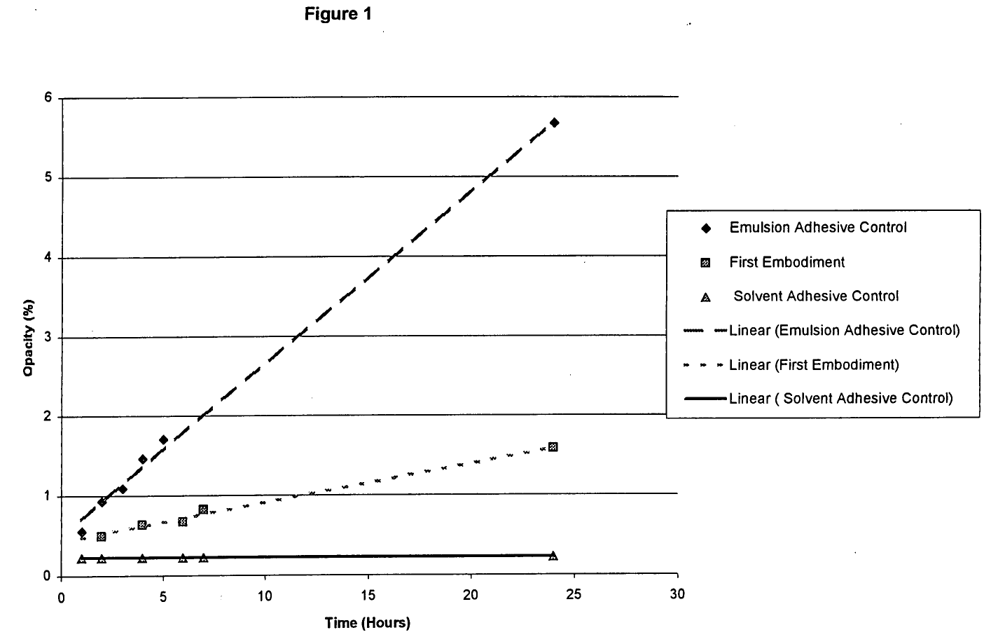

Adhesive performance data for the emulsion copolymers prepared in Examples 1 and 2 are presented in FIGS. 1 through 5. Comparative data from one or more commercial products is also presented.

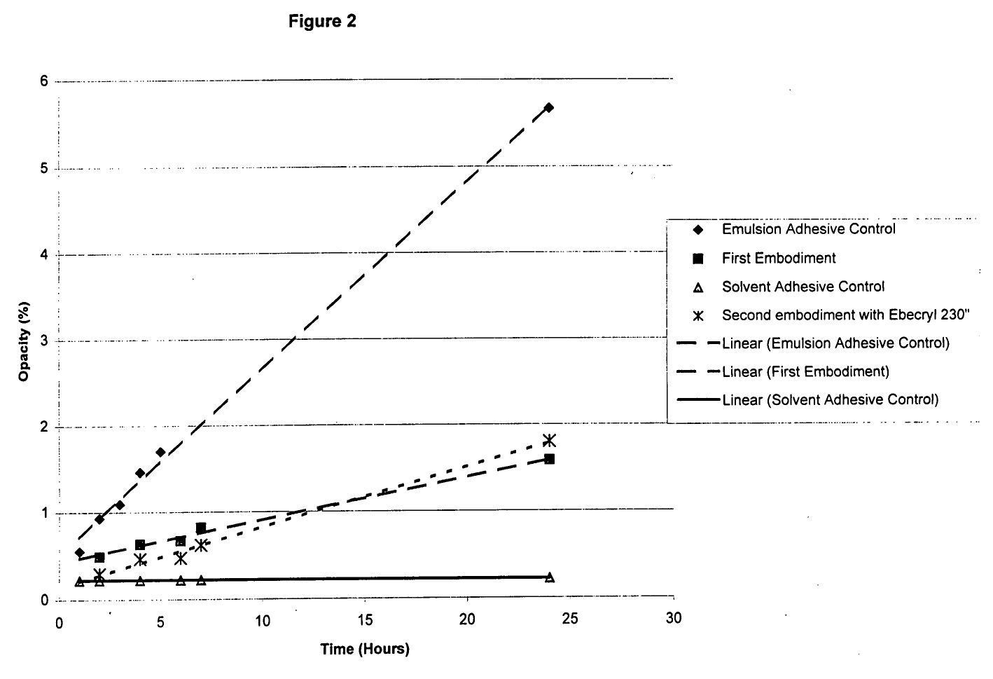

An opacity test was conducted to determine water-whitening resistance. The pressure-sensitive adhesive compositions prepared in Examples 1 and 2 were coated to a level of 23±1 g/m² on 2 mil silicone-coated Mylar® release liners with a wire rod. The samples were dried for about 8 minutes in an 80° C. oven. The samples were then cooled and laminated onto 2 mil 940 clear vinyl facestocks with a 5 or 10 pound roller. The unwanted edges were cut off, and the samples were run through the lamination machine twice to eliminate air bubbles. The samples were set aside for 24 hours to allow any remaining trapped air to escape. The Mylar® release liners were then removed, and the samples were submerged in 22° C. deionized water. The opacity of each sample was tested every two hours using a Hunterlab Colorquest Spectrocolorimeter according to standards set forth in ASTM D 2805-88, “Standard Test Method for Hiding Power of Paints by Reflectometry,” and T425 om-96, “Opacity of Paper (15/d geometry illuminant A/2°, 89% reflectance backing and paper backing). The emulsion copolymers prepared in Examples 1 and 2 were tested against both an emulsion pressure-sensitive adhesive control and a solvent pressure-sensitive adhesive control. The emulsion pressure-sensitive adhesive control comprised an emulsion copolymer not including Norsocryl® Matrife, Norsocryl® 104 or Ebecryl® 203. The results of the opacity test conducted on the emulsion copolymer prepared in Example 1 are reported in the chart depicted in FIG. 1. The results of the opacity test conducted on the emulsion copolymer prepared in Example 2 are reported in the chart depicted in FIG. 2. The results in FIGS. 1 and 2 demonstrate that emulsion adhesives containing Norsocryl® Matrife and Norsocryl® 104 are substantially more resistant to water-whitening than those emulsion adhesives that do not contain those monomers. The results also show that emulsion adhesives further containing Ebecryl® 203 exhibit increased resistance to water-whitening.

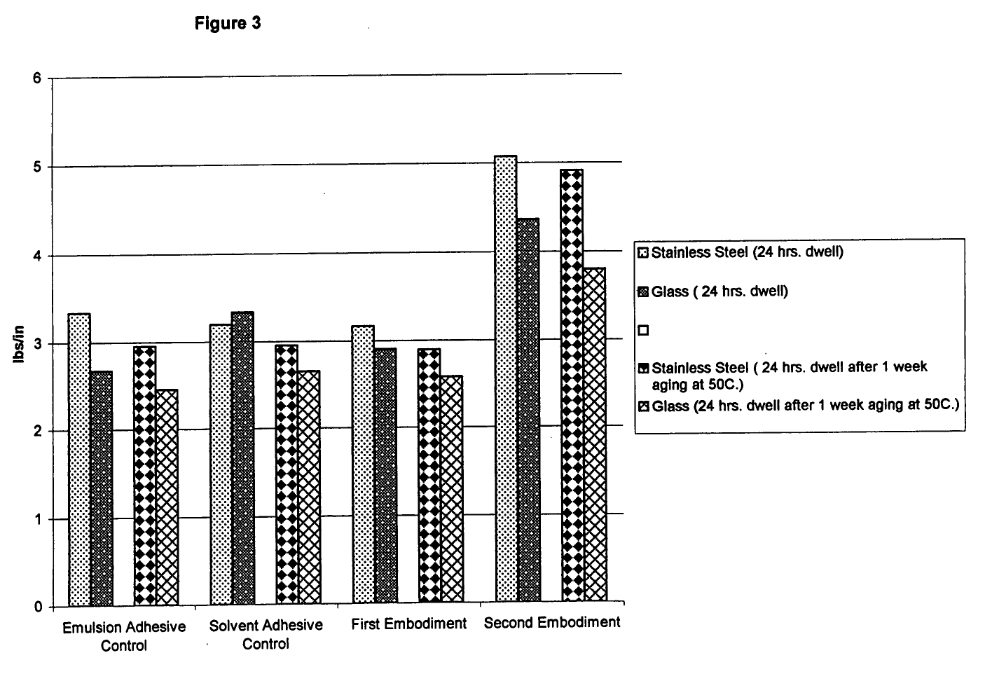

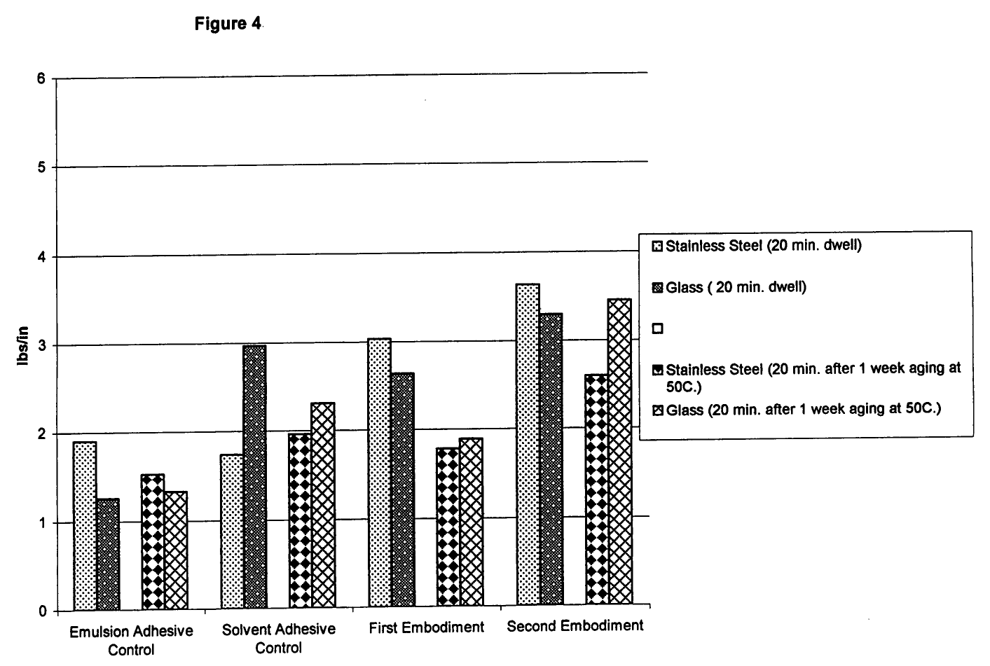

180° peel is a measure of the force required to remove a pressure-sensitive adhesive-coated flexible facestock from a substrate after a specified dwell period, at a 180° angle. This test was performed using a Pressure-Sensitive Tape Council (PSTC) test method. The pressure-sensitive adhesives were coated on black vinyl film to a level of 23±1 g/m², the dwell time was 20 minutes or 24 hours, and the pull rate was 305 mm/min. The peel was performed on substrates of glass and stainless steel. The emulsion copolymers prepared in Examples 1 and 2 were again tested against both an emulsion pressure-sensitive adhesive control and a solvent pressure-sensitive adhesive control. These controls were the same as in the opacity tests described above. The results of this 180° peel test conducted on the emulsion copolymers prepared in Examples 1 and 2 are reported in the charts depicted in FIGS. 3 and 4. Typically, as demonstrated by the results in FIGS. 3 and 4, as the opacity of the emulsion pressure-sensitive adhesive improves, the peel adhesion worsens. However, the results in FIGS. 3 and 4 demonstrate that the emulsion copolymer containing Ebecryl® 203 has better 180° peel adhesion than those emulsion copolymers not containing that oligomer.

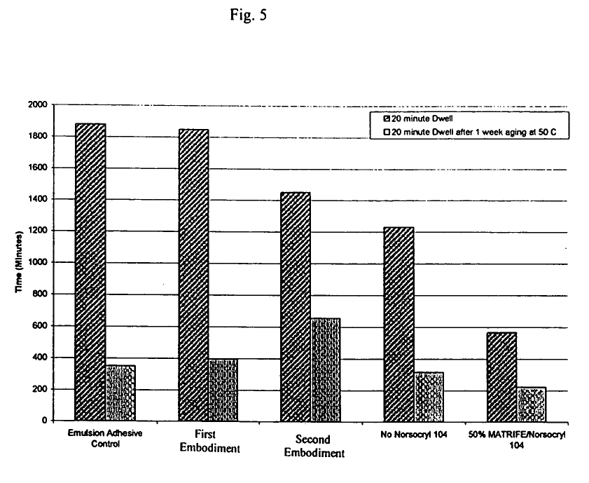

Shear strength is a measure of the cohesiveness or internal strength of the pressure-sensitive adhesive. Shear strength was determined using a PSTC test method, with a static load of 500 g and sample-on-panel overlap dimensions of ½″×½″. Tests were performed on panels inclined 2° from vertical. The emulsion copolymers prepared in Examples 1 and 2 were tested only against the emulsion control. The shear strength of the samples were tested after a 20 minute dwell time. The samples were also tested after aging for one week at 50° C. Shear strength typically drops after aging due to plasticizer migration. The emulsion copolymer prepared in Example 2 showed better shear strength after aging. The results of this shear strength test are reported in the chart depicted in FIG. 5. The results in FIG. 5 demonstrate that emulsion copolymers containing Norsocryl® 104 and Norsocryl® Matrife have better shear strength than those emulsion copolymers not containing those monomers. In addition, the results demonstrate that emulsion copolymers further containing Ebecryl® 203 have the best shear strength of the tested emulsion copolymers.

The present invention has been described in preferred and exemplary embodiments and aspects, but is not limited thereto. Persons skilled in the art will appreciate that other modifications and applications can be made without meaningfully departing from the invention. For example, the copolymers referred to herein have been described as being prepared by emulsion polymerization, but are not limited thereto. Bulk polymerization and solvent polymerization are alternative avenues for polymer preparation. Accordingly, the foregoing description should not be read as limited to the precise embodiments and aspects described, but should be read consistent with and as support for the following claims, which are to have their fullest and fairest scope.

Throughout the text and the claims, use of the word “about” in relation to a range of values is intended to modify both the high and low values recited, and reflects the penumbra of variation associated with measurement, significant figures, and interchangeability, all as understood by a person having ordinary skill in the art to which this invention pertains.

1. A pressure-sensitive adhesive composition comprising a copolymer formed from a plurality of monomers that includes:
(a) a plurality of (meth)acrylic monomers;
(b) at least one trifluoroalkyl(meth)acrylate monomer; and
(c) at least one alkylimidazolidone (meth)acrylate monomer.

2. A pressure-sensitive adhesive composition according to claim 1, wherein the plurality of monomers further includes at least one aliphatic urethane di(meth)acrylate.

3. A pressure-sensitive adhesive composition according to claim 1, wherein the at least one trifluoroalkyl(meth)acrylate monomer comprises trifluoroethyl methacrylate.

4. A pressure-sensitive adhesive composition according to claim 1, wherein the at least one alkylimidazolidone (meth)acrylate monomer comprises ethylimidazolidone methacrylate.

5. A pressure-sensitive adhesive composition according to claim 2, wherein the at least one aliphatic urethane di(meth)acrylate comprises an aliphatic urethane diacrylate having a molecular weight of about 5,000 g/mol.

6. A pressure-sensitive adhesive composition according to claim 1, further comprising a surfactant system comprising at least one surfactant.

7. A pressure-sensitive adhesive composition according to claim 6, wherein the surfactant system comprises at least one surfactant having an ethylene oxide content of about 30 moles ethylene oxide to 1 mole surfactant.

8. A pressure-sensitive adhesive composition according to claim 6, wherein the at least one surfactant comprises at least one anionic surfactant and at least one nonionic surfactant.

9. A pressure-sensitive composition according to claim 1, wherein the composition is crosslinked with at least one crosslinking agent.

10. A pressure-sensitive adhesive composition comprising a copolymer formed from a plurality of monomers that includes:
(a) a plurality of soft monomers;
(b) at least one hard monomer;
(c) at least one acid monomer;
(d) at least one trifluoroalkyl(meth)acrylate monomer; and
(e) at least one alkylimidazolidone (meth)acrylate monomer.

11. A pressure-sensitive adhesive composition according to claim 10, wherein the plurality of soft monomers is selected from the group consisting of alkyl acrylates having 4 to 12 carbon atoms in the alkyl group.

12. A pressure-sensitive adhesive composition according to claim 10, wherein the plurality of soft monomers comprises 2-ethylhexyl acrylate and butyl acrylate.

13. A pressure-sensitive adhesive composition according to claim 10, wherein the at least one hard monomer is selected from the group consisting of styrene, methyl methacrylate, n-hexyl methacrylate, ethyl methacrylate, isobutyl methacrylate, and n-butyl methacrylate.

14. A pressure-sensitive adhesive composition according to claim 10, wherein the at least one hard monomer comprises styrene and methyl methacrylate.

15. A pressure-sensitive adhesive composition according to claim 10, wherein the at least one acid monomer is selected from the group consisting of methacrylic acid, acrylic acid, itaconic acid and fumaric acid.

16. A pressure-sensitive adhesive composition according to claim 10, wherein the at least one acid monomer comprises methacrylic acid and acrylic acid.

17. A pressure-sensitive adhesive composition according to claim 10, wherein the plurality of monomers further includes at least one aliphatic urethane di(meth)acrylate.

18. A pressure-sensitive adhesive composition according to claim 17, wherein the at least one aliphatic urethane di(meth)acrylate comprises an aliphatic urethane diacrylate having a molecular weight of about 5,000 g/mol.

19. A pressure-sensitive adhesive composition according to claim 10, further comprising a surfactant system comprising at least one surfactant.

20. A pressure-sensitive adhesive composition according to claim 19, wherein the surfactant system comprises at least one surfactant having an ethylene oxide content of about 30 moles ethylene oxide to 1 mole surfactant.

21. A pressure-sensitive adhesive composition according to claim 19, wherein the at least one surfactant comprises at least one anionic surfactant and at least one nonionic surfactant.

22. A pressure-sensitive adhesive composition according to claim 10, wherein the composition is crosslinked with at least one crosslinking agent.

23. A pressure-sensitive adhesive composition comprising an emulsion copolymer formed from a plurality of monomers that includes:
(a) 2-ethylhexyl acrylate;
(b) butyl acrylate;
(c) methyl methacrylate;
(d) styrene;
(e) methacrylic acid;
(f) acrylic acid;
(g) trifluoroethyl methacrylate; and
(h) ethylimidazolidone methacrylate.

24. A pressure-sensitive adhesive composition according to claim 23, wherein the plurality of monomers further includes at least one aliphatic urethane di(meth)acrylate.

25. A pressure-sensitive adhesive composition according to claim 24, wherein the at least one aliphatic urethane di(meth)acrylate comprises aliphatic urethane diacrylate having a molecular weight of about 5,000 g/mol.

26. A pressure-sensitive adhesive composition according to claim 23, further comprising a surfactant system comprising at least one surfactant.

27. A pressure-sensitive adhesive composition according to claim 26, wherein the surfactant system comprises at least one surfactant having an ethylene oxide content of about 30 moles ethylene oxide to 1 mole surfactant.

28. A pressure-sensitive adhesive composition according to claim 26, wherein the at least one surfactant comprises at least one anionic surfactant and at least one nonionic surfactant.

29. A pressure-sensitive adhesive composition according to claim 23, wherein the plurality of monomers further includes at least one chain transfer agent.

30. A pressure-sensitive adhesive composition according to claim 23, wherein the composition is crosslinked with at least one crosslinking agent.

31. A pressure-sensitive adhesive composition according to claim 23, wherein the plurality of monomers, on percent-by-weight basis, based on the total weight of monomers, consists essentially of:
(a) about 10% to 22% 2-ethylhexyl acrylate;
(b) about 58% to 70% butyl acrylate;
(c) about 3% to 8% methyl methacrylate;
(d) about 1% to 5% styrene;
(e) about 2% to 5% methacrylic acid;
(f) about 2% to 5% acrylic acid;
(g) about 0.5% to 2.5% trifluoroethyl methacrylate; and
(h) a positive amount up to about 1% ethylimidazolidone methacrylate.

32. A pressure-sensitive adhesive composition according to claim 31, wherein the plurality of monomers further includes at least one aliphatic urethane di(meth)acrylate, in a total amount of up to about 1.6% by weight.

33. A pressure-sensitive adhesive composition according to claim 32, wherein the at least one aliphatic urethane di(meth)acrylate comprises an aliphatic urethane diacrylate having a molecular weight of about 5,000 g/mol.

34. A pressure-sensitive adhesive composition comprising an emulsion copolymer formed from a plurality of monomers that includes, on a percent-by-weight basis, based on the total weight of monomers:
(a) about 80% to 90% of a plurality of soft monomers;
(b) about 3% to 10% of a plurality of hard monomers;
(c) about 3% to 8% of a plurality of acid monomers;
(d) a positive amount up to about 1% of at least one alkylimidazolidone (meth)acrylate monomer; and
(e) about 0.5% to 2.5% of at least one trifluoroalkyl(meth)acrylate monomer.

35. A pressure-sensitive adhesive composition according to claim 34, wherein the plurality of monomers further includes at least one aliphatic urethane di(meth)acrylate, in a total amount of up to about 1.6% by weight, based on the total weight of the plurality of monomers.

36. A pressure-sensitive adhesive composition according to claim 35, wherein the at least one aliphatic urethane di(meth)acrylate comprises an aliphatic urethane diacrylate having a molecular weight of about 5,000 g/mol.

37. A pressure-sensitive adhesive composition comprising an emulsion copolymer formed from a plurality of monomers that includes, on a percent-by-weight basis, based on the total weight of monomers:
(a) about 80% to 90% of a plurality of soft monomers, selected from the group consisting of alkyl acrylates having 4 to 12 carbon atoms in the alkyl group;
(b) about 3% to 10% of at least one hard monomer, selected from the group consisting of styrene, methyl methacrylate, n-hexyl methacrylate, ethyl methacrylate, isobutyl methacrylate and n-butyl methacrylate;
(c) about 3% to 8% of at least one acid monomer, selected from the group consisting of methacrylic acid, acrylic acid, itaconic acid and fumaric acid;
(d) a positive amount up to about 1% of at least one alkylimidazolidone (meth)acrylate monomer; and
(e) about 0.5% to 2.5% of at least one trifluoroalkyl(meth)acrylate monomer.

38. A pressure-sensitive adhesive composition according to claim 37, wherein the plurality of monomers further includes at least one aliphatic urethane di(meth)acrylate, in a total amount of up to about 1.6% by weight, based on the total weight of the plurality of monomers.

39. A pressure-sensitive adhesive composition according to claim 38, wherein the at least one aliphatic urethane di(meth)acrylate comprises an aliphatic urethane diacrylate having a molecular weight of about 5,000 g/mol.

40. A pressure-sensitive adhesive composition according to claim 37, wherein the plurality of soft monomers comprises:
(a) 2-ethylhexyl acrylate, in a total amount of from about 10% to 22% by weight, based on the total weight of the plurality of monomers; and
(b) butyl acrylate, in a total amount of from about 58% to 70% by weight, based on the total weight of the plurality of monomers.

41. A pressure-sensitive adhesive composition according to claim 37, wherein the at least one hard monomer comprises:
(a) methyl methacrylate, in a total amount of from about 3% to 8% by weight, based on the total weight of the plurality of monomers; and
(b) styrene, in a total amount of from about 1% to 5% by weight, based on the total weight of the plurality of monomers.

42. A pressure-sensitive adhesive composition according to claim 37, wherein the at least one acid monomer comprises:
(a) acrylic acid, in a total amount of from about 2% to 5% by weight, based on the total weight of the plurality of monomers; and
(b) methacrylic acid, in a total amount of from about 2% to 5% by weight, based on the total weight of the plurality of monomers.

43. A pressure-sensitive adhesive composition according to claim 37, further comprising a surfactant system comprising at least one surfactant.

44. A pressure-sensitive adhesive composition according to claim 43, wherein the surfactant system comprises at least one surfactant having an ethylene oxide content of about 30 moles ethylene oxide to 1 mole surfactant.

45. A pressure-sensitive adhesive composition according to claim 43, wherein the at least one surfactant comprises at least one anionic surfactant and at least one nonionic surfactant.

46. A pressure-sensitive adhesive composition according to claim 37, wherein the composition is crosslinked with at least one crosslinking agent.

47. An adhesive construction comprising a pressure-sensitive adhesive composition according to any one of claims 1, 10, 23, 34, or 37, coated on or laminated to a facestock.

48. An adhesive construction according to claim 47, wherein the facestock comprises a vinyl film.
